(19) United States
(12) Patent Application Publication
(10) Pub. No.: US 2026/0038087 A1
(43) Pub. Date: Feb. 5, 2026

(54) METHOD AND ELECTRONIC DEVICE FOR PERFORMING CONVOLUTIONAL NEURAL NETWORK OPERATIONS ON BATCH OF INPUT IMAGES USING HOMOMORPHIC ENCRYPTION

(71) Applicant: CRYPTO LAB INC., Seoul (KR)

(72) Inventors: Guillaume Hanrot, Seoul (KR); Simeon Laporte, Seoul (KR)

(21) Appl. No.: 19/286,605

(22) Filed: Jul. 31, 2025

(30) Foreign Application Priority Data
Jul. 31, 2024 (KR) 10-2024-0102038
Jul. 30, 2025 (KR) 10-2025-0104111

(51) Int. Cl. G06T 5/20; H04L 9/00

(52) U.S. Cl. CPC G06T 5/20; H04L 9/008; G06T 2207/20084

(57) ABSTRACT

Provided are a method and an electronic device for performing convolutional neural network operations on a batch of input images using homomorphic encryption. The method includes: for each channel of the batch of the input images, grouping pixel values at the same location in the images included in the batch into a single vector, and encrypting the grouped vectors using a homomorphic encryption method to obtain a first ciphertext; for each channel and each coefficient of the ciphertext, grouping coefficients of the first ciphertext corresponding to all pixel locations to generate polynomials, and configuring the polynomials into a single matrix; multiplying the matrix by a polynomial matrix representing a convolution filter to obtain a result matrix, and performing a modulo operation on each element of the result matrix to generate an encrypted convolution operation result, the operation being performed on unencrypted matrices; and rearranging polynomial coefficients of the result matrix to generate a second ciphertext for the batch of the images after the convolution layer is applied, in which the second ciphertext is encrypted by the same homomorphic encryption method as the first ciphertext.

### TECHNICAL FIELD

Apparatuses and methods consistent with the disclosure relate to a method and an electronic device for performing convolutional neural network operations on a batch of input images using homomorphic encryption.

### BACKGROUND ART

As communication technology develops and electronic devices spread, efforts are continuously made to maintain communication security between the electronic devices. Accordingly, encryption/decryption technology is used in most communication environments.

When messages encrypted by the encryption technology are delivered to the other party, the other party needs to perform decryption in order to use the messages. In this case, the other party wastes resources and time in the process of decrypting the encrypted data. In addition, when the third party hacks messages while the other party temporarily decrypts the messages for operation, there is a problem in that the messages may be easily leaked to the third party.

In order to solve this problem, a homomorphic encryption method is being studied. According to the homomorphic encryption, even if an operation is performed on ciphertexts themselves without decrypting the encrypted information, it is possible to obtain the same result as the encrypted value after an operation on a plain text. Accordingly, various types of processing may be performed without decrypting the ciphertexts.

Meanwhile, the convolutional neural networks (CNNs) are a cutting-edge artificial intelligence solution for various image processing tasks, including image classification. The structure of the neural network is composed of alternating convolutional layers that combine various parts of an image to extract relevant information, and activation layers that individually act on each pixel of each part of the image.

In this case, as the importance of security increases when performing operations on convolutional neural networks, a method for performing operations on convolutional neural networks using homomorphic encryption is requested.

### DISCLOSURE OF INVENTION

### Solution to Problem

The present disclosure has been made to solve the above-described problems, and provides a method and an electronic device for performing convolutional neural network operations with guaranteed privacy protection and security on a batch of input images by using homomorphic encryption and converting a homomorphic operation into a product of unencrypted polynomial matrices.

In accordance with an aspect of the disclosure, a method for performing convolutional neural network operations on a batch of input images using homomorphic encryption includes: for each channel of the batch of the input images, grouping pixel values at the same location in the images included in the batch into a single vector, and encrypting the grouped vectors using a homomorphic encryption method to obtain a first ciphertext; for each channel and each coefficient of the ciphertext, grouping coefficients of the first ciphertext corresponding to all pixel locations to generate polynomials, and configuring the polynomials into a single matrix; multiplying the matrix by a polynomial matrix representing a convolution filter to obtain a result matrix, and performing a modulo operation on each element of the result matrix to generate an encrypted convolution operation result, the operation being performed on unencrypted matrices; and rearranging polynomial coefficients of the result matrix to generate a second ciphertext for the batch of the images after the convolution layer is applied, in which the second ciphertext is encrypted by the same homomorphic encryption method as the first ciphertext.

The first ciphertext and the second ciphertext may be generated using an approximate homomorphic encryption scheme of a Cheon-Kim-Kim-Song (CKKS) method.

The polynomial matrix may be composed of a kernel having a rectangular or squared shape.

The method may further include: converting the polynomial matrix into a scalar matrix using an number theoretic transform (NTT) or a discrete Fourier transform (DFT) to evaluate a multiplication of the polynomial matrix, multiplying the scalar matrices, and then obtaining a product of the polynomial matrix through a corresponding inverse transformation.

The method may further include: performing a preprocessing or postprocessing process including stride, downsampling, or invalid pixel removal by discarding one ciphertext from the entire batch.

The method may be applied to a three-dimensional convolution operation on a plurality of image frames or video data.

In accordance with another aspect of the disclosure, an electronic device includes: a memory configured to store instructions; and a processor configured to execute the instructions, in which the processor is configured to for each channel of the batch of the input images, group pixel values at the same location in the images included in the batch into a single vector, and encrypt the grouped vectors using a homomorphic encryption method to obtain a first ciphertext, for each channel and each coefficient of the ciphertext, group coefficients of the first ciphertext corresponding to all pixel locations to generate polynomials, and configure the polynomials into a single matrix, multiply the matrix by a polynomial matrix representing a convolution filter to obtain a result matrix, and perform a modulo operation on each element of the result matrix to generate an encrypted convolution operation result, the operation being performed on unencrypted matrices, and rearrange polynomial coefficients of the result matrix to generate a second ciphertext for the batch of the images after the convolution layer is applied, and the second ciphertext is encrypted by the same homomorphic encryption method as the first ciphertext.

The first ciphertext and the second ciphertext may be generated using an approximate homomorphic encryption scheme of a Cheon-Kim-Kim-Song (CKKS) method.

The polynomial matrix may be composed of a kernel having a rectangular or squared shape.

The processor may be configured to convert the polynomial matrix into a scalar matrix using number theoretic transform (NTT) or discrete Fourier transform (DFT) to evaluate a multiplication of the polynomial matrix, multiply the scalar matrices, and then obtain a product of the polynomial matrix through a corresponding inverse transformation.

The processor may be configured to perform a preprocessing or postprocessing process including stride, downsampling, or invalid pixel removal by discarding one ciphertext from the entire batch.

### BRIEF DESCRIPTION OF DRAWINGS

FIG. 1 is a diagram for describing a structure of a network system according to an embodiment of the present disclosure.

FIG. 2 is a block diagram illustrating a simple configuration of an electronic device according to an embodiment of the present disclosure.

FIG. 3 is a block diagram illustrating a specific configuration of the electronic device according to an embodiment of the present disclosure.

FIG. 4 is a flowchart for describing a method for performing a convolutional layer operation of a convolutional neural network according to an embodiment of the present disclosure.

### MODE FOR INVENTION

Hereinafter, the present disclosure will be described in detail with reference to the accompanying drawings. Encryption/decryption may be applied to an information (data) transmission process performed in the present disclosure, if necessary, and all expressions describing the information (data) transmission process in the present disclosure and claims should be interpreted as including cases of encryption/decryption even if not separately stated. In the present disclosure, expressions such as “transmission (delivery) from A to B” or “A receiving from B” include transmission (delivery) or reception with another medium included therebetween, and do not necessarily express only what is directly transmitted (delivered) or received from A to B.

In the description of the present disclosure, the order of each step should be understood as non-limiting unless the preceding step needs to be logically and temporally performed necessarily before the following step. In other words, except for the above exceptional cases, even if the process described as the following step is performed before the process described as the preceding step, the nature of the disclosure is not affected, and the scope should also be defined regardless of the order of the steps. In this specification, “A or B” is defined to mean not only selectively indicating either one of A and B, but also including both A and B. In addition, in the present disclosure, the term “include” has a meaning encompassing further including other components in addition to elements listed as included.

In this disclosure, only essential components necessary for the description of the present disclosure are described, and components unrelated to the essence of the present disclosure are not mentioned. In addition, it should not be interpreted as an exclusive meaning that includes only the mentioned components, but should be interpreted as a non-exclusive meaning that may include other components.

In addition, in the present disclosure, “value” is defined as a concept including a vector as well as a scalar value. In the present disclosure, the expressions such as “compute,” and “calculate” may be replaced by an expression that produces a result of the corresponding computation or calculation. In addition, unless otherwise stated, an operation on a ciphertext to be described below means a homomorphic operation. For example, an addition of a homomorphic ciphertext means a homomorphic addition of two homomorphic ciphertexts.

Mathematical operations and calculations of each step of the present disclosure to be described below may be implemented as computer operations by the known coding method and/or coding designed to suit the present disclosure.

Specific equations to be described below are illustratively described among possible alternatives, and the scope of the present disclosure should not be construed as being limited to equations mentioned in the present disclosure.

For convenience of description, in the present disclosure, a notation is defined as follows.
a←D: Select element (a) according to distribution (D)
s1, s2ϵR: Each of S1 and S2 is an element belonging to set R.
mod(q): Modular operation with element q
└·┐: Round-off internal value

Hereinafter, various embodiments of the present disclosure will be described in detail with reference to the accompanying drawings.

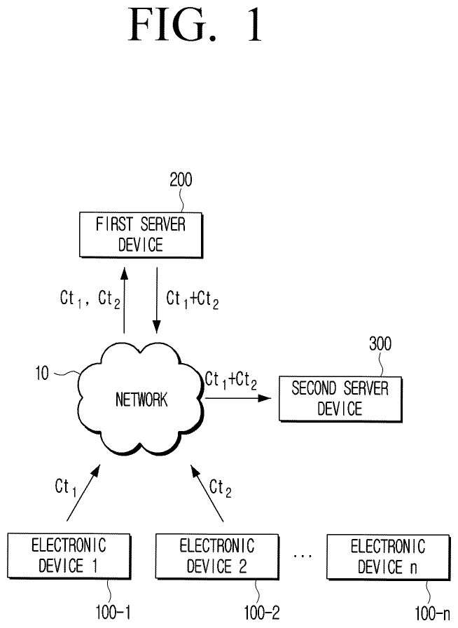

FIG. 1 is a diagram for describing a structure of a network system according to an embodiment of the present disclosure.

Referring to FIG. 1, a network system may include a plurality of electronic devices 100-1 to 100-n, a first server device 200, and a second server device 300, each of which may be connected to each other through a network 10.

The network 10 may be implemented in various types of wired and wireless communication networks, broadcast communication networks, optical communication networks, cloud networks, etc., and each device may be connected in a manner such as Wi-Fi, Bluetooth, near field communication (NFC), etc. without a separate medium.

Although FIG. 1 illustrates a plurality of electronic devices 100-1 to 100-n, a plurality of electronic devices are not necessarily used, and one device may be used. For example, the electronic devices 100-1 to 100-n may be implemented as various types of devices such as smartphones, tablets, game players, PCs, laptop PCs, home servers, and kiosks. In addition, the electronic devices 100-1 to 100-n may be implemented in the form of home appliances to which an IoT function is applied.

Users may input various types of information through the electronic devices 100-1 to 100-n they use. The input information may be stored in the electronic devices 100-1 to 100-n themselves, but may also be transmitted to and stored in an external device for reasons such as storage capacity and security. In FIG. 1, the first server device 200 may serve to store such information, and the second server device 300 may serve to use some or all of the information stored in the first server device 200.

Each of the electronic devices 100-1 to 100-n may homomorphically encrypt the input information and transmit the homomorphic ciphertexts to the first server device 200.

Each of the electronic devices 100-1 to 100-n may include encryption noise, i.e., an error, generated in the process of performing homomorphic encryption in a ciphertext. Specifically, the homomorphic ciphertexts generated by each of the electronic devices 100-1 to 100-n may be generated in a form in which a result value including a message and an error value is restored when decrypted later using a secret key.

For example, when the homomorphic ciphertexts generated by the electronic devices 100-1 to 100-n are decrypted using a secret key, the homomorphic ciphertexts may be generated in a form that satisfies the following natures.

$$Dec ( ct , sk ) = 〈 ct , sk 〉 = M + e ( mod q ) \qquad 〈 Equation 1 〉$$

Here, <, > denotes a dot product operation (usual inner product), ct denotes a ciphertext, sk denotes a secret key, M denotes a plain text message, e denotes an encryption error value, and mod q denotes a modulus of a ciphertext. q should be selected to be larger than a result value M obtained by multiplying a scaling factor Δ by a message. When an absolute value of the error value e is sufficiently small compared to M, a decryption value M+e of the ciphertext is a value that may replace the original message with the same precision in significant figure operation. Among the decrypted data, an error may be arranged on the least significant bit (LSB) side, and M may be arranged on the next least significant bit side.

When a size of the message is too small or too large, the size may be adjusted using a scaling factor. When the scaling factor is used, not only an integer type message but also a real number type message may be encrypted, and thus, the usability of the message may be greatly increased. In addition, by adjusting the size of the message using the scaling factor, a size of an area where messages exist in the ciphertext after the operation is made, that is, a size of an effective area may also be adjusted.

Depending on the embodiment, a modulus q of the ciphertext may be set and used in various forms. For example, the modulus of the ciphertext may be set in the form of an exponential power q=Δ^{L} of the scaling factor Δ. When Δ is 2, Δ may be set to a value such as q=2¹⁰.

In addition, the homomorphic ciphertext according to the present disclosure is described on the assumption that a fixed point is used, but may be applied even when a floating point is used.

The first server device 200 may store the received homomorphic ciphertext in a ciphertext state without decrypting the homomorphic ciphertext.

The second server device 300 may request a specific processing result for the homomorphic ciphertext from the first server device 200. The first server device 200 may perform a specific operation according to the request of the second server device 300 and then transmit the result to the second server device 300.

For example, when ciphertexts ct1 and ct2 transmitted by the two electronic devices 100-1 and 100-2 are stored in the first server device 200, the second server device 300 may request, from the first server device 200, a value obtained by summing the information provided from the two electronic devices 100-1 and 100-2. The first server device 200 may perform an operation for summing the two ciphertexts according to the request, and then transmit the result value ct1+ct2 to the second server device 300.

Due to the nature of the homomorphic ciphertext, the first server device 200 may perform the operation without performing the decryption, and the result value is also in the form of the ciphertext. In the present disclosure, the result value obtained by the operation is called a homomorphic operation ciphertext (or operation result ciphertext).

The first server device 200 may transmit the operation result ciphertext to the second server device 300. The second server device 300 may decrypt the received operation result ciphertext and acquire operation result values of data included in each homomorphic ciphertext.

Meanwhile, FIG. 1 illustrates a case where the first electronic device and the second electronic device perform the encryption and the second server device performs the decryption, but is not necessarily limited thereto.

Meanwhile, the convolutional neural network (CNN) is widely used in image processing, and the convolutional layer may extract features corresponding to the image by performing an operation on a specific area of the input image with a filter.

In an embodiment of the present disclosure, the convolutional neural network may receive N/2 batches of images as input. Here, each image may include Cᵢₙ channels, and each channel may include h×w pixels. For a pixel position (i,j) and a channel k, the electronic device may bundle all image pixel values at the corresponding position into a vector and encrypt them as a single ciphertext. The electronic device may express the ciphertext in a polynomial form, extract coefficients, and configure a second-order polynomial matrix. The electronic device may configure a polynomial matrix representing a convolution filter, multiply the second-order polynomial matrix and the convolution filter to obtain a result matrix, and perform a modulo operation on each element of the result matrix. In addition, the electronic device may rearrange the polynomial coefficients of the result matrix to generate a second ciphertext for the batch of images after which the convolution layer is applied.

By the method as described above, by utilizing the homomorphic encryption, it is possible to efficiently perform convolutional layer operation of a convolutional neural network on a plurality of batches of images.

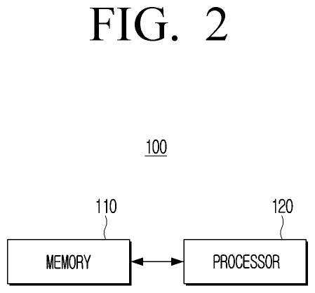

FIG. 2 is a block diagram illustrating a simple configuration of an electronic device according to an embodiment of the present disclosure.

Referring to FIG. 2, the electronic device 100 includes a memory 110 and a processor 120.

The memory 110 is a component for storing various instructions and/or software, data, etc. related to the generation and operation processing of a homomorphic ciphertext described below or an O/S for driving the electronic device 100. The memory 110 may be implemented in various forms such as RAM, ROM, flash memory, HDD, external memory, and memory card, but is not limited to any one.

The memory 110 stores the message to be encrypted. Here, the message may be various types of credit information, personal information, and the like cited by a user, and may also be information related to location information used in the electronic device 100 and a use history such as Internet usage time information. Alternatively, such a message may be user's spoken voice or text resulting from TTS of the above-described voice. Here, the message to be encrypted may be called plaintext data.

In one or more embodiments, the memory 110 may store the plurality of batches of images.

In addition, the memory 110 may store a public key, and when the electronic device 100 is a device that directly generates the public key, the memory 110 may store not only a secret key, but also various parameters necessary for generating the public key and the secret key.

In addition, the memory 110 may store a homomorphic ciphertext (for example, a merged homomorphic ciphertext or a homomorphic ciphertext resulting from a homomorphic operation, etc.) generated in the process described below. In this case, the ciphertext stored in the memory 110 may be a ciphertext in the LWE method, but is not limited thereto.

The processor 120 controls each component in the electronic device 100. The processor 120 may be composed of a single device such as a central processing unit (CPU) and an application-specific integrated circuit (ASIC), or may be composed of a plurality of devices such as a CPU and a graphics processing unit (GPU).

When a message to be transmitted is input, the processor 120 stores the message in the memory 110. The processor 120 may use various setting values and programs stored in the memory 110 to homomorphically encrypt the message. In this case, the public key may be used.

The processor 120 may generate and use a public key required to perform encryption by itself, or may receive and use the public key from an external device. For example, the second server device 300 that performs the decryption may distribute a public key to other devices.

When generating a key by itself, the processor 120 may generate a public key using a Ring-LWE technique. Specifically, the processor 120 may first set various parameters and rings and store them in the memory 110. Examples of the parameters may include a length of a plaintext message bit, dimension n, rank k, sizes of public and secret keys, etc. There are various forms of homomorphic ciphertexts, and the processor 120 may configure a ring according to a ciphertext method set by a user or a predetermined method. For example, the homomorphic ciphertext method described above may be a CKKS scheme, an RLWE scheme, etc.

The ring may be represented by the following equation.

$$R = {Z}_{q} [ X ] / f ( x ) \qquad [ Equation 2 ]$$

Here, R denotes a ring, Zq denotes a coefficient, and f(x) denotes an n-th polynomial.

The ring is a set of polynomials having predetermined coefficients, and means a set in which addition and multiplication are defined between elements and which is closed for addition and multiplication. Such a ring may be referred to as an annulus.

For example, the ring means a set of n-th polynomials having a coefficient Zq. Specifically, when n is Φ(N), it means polynomials that may be produced as the remainder when dividing a polynomial by an N-th cyclotomic polynomial. f(x) denotes ideal of Zq[x] generated by the f(x). The Euler totient function Φ(N) means the number of natural numbers that is coprime to N and smaller than N.

The ring used in the above-described MLWE may be expressed as the following Equation 3.

$${R}_{q , N} = {Z}_{q} [ {X}_{( N )} ] / ( {X}_{( N )}^{N} + 1 ) \qquad [ Equation 3 ]$$

Here, q denotes the modulus, k denotes the rank, and N denotes the dimension. Meanwhile, it is assumed that the above-described ring is MLWE. When using the LWE, N may be substituted with 1 and used, and in the RLWE method, k may be substituted with 1 and used.

When such a ring is established, the processor 120 may calculate the secret key sk from the ring.

$$s k ← ( 1 , s ( x ) ) , s ( x ) ∈ R \qquad [ Equation 4 ]$$

Here, s(x) means a polynomial generated randomly with small coefficients.

When the ring and the secret key are selected, the processor 120 derives a first random polynomial (a(x)) from the ring. The first random polynomial may be represented as follows.

$$a ( x ) ← R \qquad [ Equation 5 ]$$

Also, the processor 120 may calculate an error. Specifically, the processor 120 may extract an error from a discrete Gaussian distribution or a distribution statistically close to the discrete Gaussian distribution. This error may be represented as follows.

$$e ( x ) ← {D}_{α q}^{n} \qquad [ Equation 6 ]$$

When an error is calculated, the processor 450 may calculate a second random polynomial by perform a modular operation on an error in the first random polynomial and the secret key. The second random polynomial may be represented as follows.

$$b ( x ) = - a ( x ) s ( x ) + e ( x ) ( mod q ) \qquad [ Equation 7 ]$$

Finally, pubic key pk is set as follows in a form including the first random polynomial and the second random polynomial.

$$p k = ( b ( x ) , a ( x ) ) \qquad [ Equation 8 ]$$

Meanwhile, when the contents of the above-described Equations 4 to 8 are examples of cases where the ckks scheme method (i.e., the RLWE method) is used, the above-described method may be modified to suit the corresponding scheme when the LWE or MLWE method is used. In addition, it is of course possible to generate the public and secret keys using methods other than those described above.

The processor 120 may generate a homomorphic ciphertext for a message. Specifically, the processor 120 may generate a homomorphic ciphertext by applying the previously generated public key to the message.

In addition, the processor 120 may perform partial decryption on the homomorphic operation ciphertext homomorphically operated by the server using its own previously acquired secret key share. According to an embodiment, the processor 120 may obtain a final decryption result by combining the partially decrypted result values by the plurality of electronic devices 100-1, . . . ,100-n.

Meanwhile, when the electronic device 100 is implemented as a transcriptor, the processor 120 may decrypt the homomorphic operation ciphertext received from the server using the secret key and broadcast the decrypted homomorphic operation ciphertext to the plurality of electronic devices 100-1, . . . ,100-n.

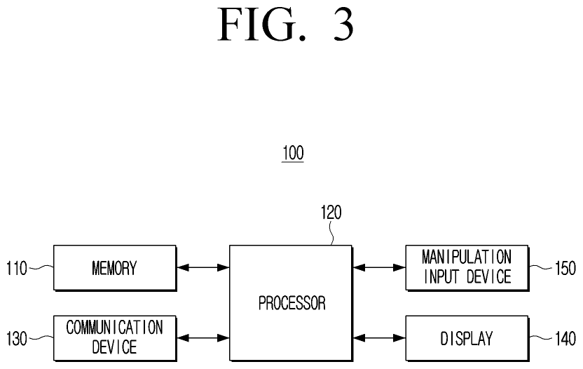

FIG. 3 is a block diagram illustrating a specific configuration of the electronic device according to an embodiment of the present disclosure.

Referring to FIG. 3, the electronic device 100 of the present disclosure may be composed of a memory 110, a processor 120, a communication device 130, a display 140, and a manipulation input device 150.

The memory 110 has been described with respect to FIG. 2, and thus a duplicate description thereof will be omitted. In addition, the processor 120 has been described with respect to FIG. 2, and thus the contents described in FIG. 2 will not be described in duplicate, and only the functions added to FIG. 3 will be described.

The communication device 130 is formed to connect the electronic device 100 to an external device (not illustrated), and may be connected to the external device through a local area network (LAN) and the Internet network or be connected to the terminal device through a USB port or a wireless communication (for example, wireless fidelity (WiFi), 802.11a/b/g/n, near field communication (NFC), or Bluetooth) port. Such a communication device 130 may also be referred to as a transceiver.

The communication device 130 may receive a public key from the external device and transmit the public key generated by the electronic device 100 to the external device.

Also, the communication device 130 may receive a message from the external device and transmit the generated homomorphic ciphertext to the external device. Conversely, the communication device 130 may also receive the ciphertext from the external device.

Also, the communication device 130 may receive various parameters required for generating the ciphertext from the external device. Meanwhile, upon implementation, various parameters may be directly received from a user through the manipulation input device 150 to be described later.

In addition, the communication device 130 may receive a pre-trained model from the outside or a weight matrix constituting the above-described model.

The display 140 displays a user interface window for selecting a function supported by the electronic device 100. Specifically, the display 140 may display a user interface window for selecting various functions provided by the electronic device 100. The display 140 may be a monitor such as LCD, CRT, and OLED, and may be implemented as a touch screen capable of simultaneously performing the functions of the manipulation input device 150 to be described later.

The display 140 may display a message requesting input of parameters necessary for generating a secret key and a public key. Also, the display 140 may display a message in which an encryption target selects a message. Meanwhile, upon implementation, the encryption target may be directly selected by a user or may be automatically selected. That is, personal information or the like that requires encryption may be automatically set even if a user does not directly select a message.

The manipulation input device 150 may receive a function selection of the electronic device 100 and a control command for the function from the user. Specifically, the manipulation input device 150 may receive parameters necessary for generating a secret key and a public key from the user. Also, the manipulation input device 150 may receive a message to be encrypted from a user.

In addition, the manipulation input device 150 may select a learning model to be applied to a plurality of homomorphic ciphertexts. Based on such a selection command, the processor 120 may perform a matrix operation with a weight matrix constituting a learning model selected from the plurality of homomorphic ciphertexts.

In addition, the manipulation input device 150 may receive a transmission command for a homomorphic ciphertext, a homomorphic operation command, etc.

When receiving parameters required for generating a secret key and a public key from a user, the processor 120 may generate setting parameters based on the input parameters and generate a secret key and a public key based on the generated setting parameters.

When it is necessary to generate a ciphertext for a message, the processor 120 may apply the public key to the message to generate the homomorphic ciphertext. Specifically, the processor 120 may convert the message into the polynomial form and apply the public key to the converted polynomial-type message to generate the homomorphic ciphertext.

Further, when the homomorphic ciphertext needs to be decrypted, the processor 120 may apply a secret key to the homomorphic ciphertext to generate a polynomial-type decrypted message, and decode the polynomial-type decrypted message to generate a message. In this case, the generated message may include an error as mentioned in Equation 1 described above.

In addition, when the operation on the homomorphic ciphertext is required, the processor 120 may perform an addition or multiplication operation on the plurality of homomorphic ciphertexts requested by the user.

As described above, the electronic device 100 according to the present embodiment may generate the homomorphic ciphertext in the message, and thus, even when the operation is required, the stability of the message may be improved. In addition, since the generated homomorphic ciphertext includes an error, stable security may be maintained for biometric information that requires high security.

Meanwhile, the electronic device 100 may perform the convolutional layer operation of the convolutional neural network on the plurality of batches of images (batch) by utilizing the homomorphic encryption.

### 1. Convolutional Layer

Specifically, the implementation of the present disclosure may focus on the convolutional layer of the convolutional neural network. The convolutional layer may receive Cᵢₙ input vectors composed of a pixel matrix

$${M}_{k}^{( i n )}$$

of size h×w and generate Cₒᵤₜ outputs composed of a pixel matrix

$${M}_{k}^{( out )}$$

of size h′×w′. If necessary, the

$${M}_{k}^{( i n )}$$

matrix may be assumed to be appropriately zero-padded. In the case of (h, w)=h′, w′), the output may be defined by the relationship such as the following Equation 9.

$${M}_{i}^{( out )} = {\sum }_{j = 0}^{{C}_{i n} - 1} {K}_{ij} * {M}_{j}^{( i n )} \qquad [ Equation 9 ]$$

Here, * is a convolution operation, and when

$${K}_{ij} = ( {K}_{ij}^{( {tt}^{′} )} ) 0 \leq t , {t}^{′} < f$$

is a matrix of dimension f×f, it may be defined as the following Equation 10.

$${( {K}_{ij} * M )}_{kl} = {\sum }_{t = 0}^{f - 1} {\sum }_{{t}^{′} = 0}^{f - 1} {K}_{ij}^{( {ti}^{′} )} \cdot {m}_{k + t , l + {t}^{′}} \qquad [ Equation 10 ]$$

However, 0≤k<h, 0≤1<w

In this case, i+l≥h, or j+l′≥w, mᵢ₊ₗⱼ₊ₖ=0

Variations of the convolution operation may include offset and stride. Here, the offset uses mᵢ₋ₒ₊ₗⱼ₋₀₊ₖ instead of m_{i+l, j+l′}, or when i<0 j or j<0, it may be considered as mᵢⱼ=0. The stride uses m_{Si+l, S′j+l′} instead of m_{i+l, j+l′}, and may be i<h/S,j<w/S′.

In addition, the operation process may include downsampling, and in this case, some pixel values of (Kᵢⱼ*M)ₖₗ may be discarded.

### 2. Homomorphic Encryption

The homomorphic encryption is a cryptographic principle that includes a computational function. That is, not only may a plaintext message be encrypted into a ciphertext and decrypted again, but also addition and multiplication operations may be performed between ciphertexts without access to a secret key, which may produce a ciphertext that is identical to the encrypted result of the addition or multiplication of the original plaintext.

The CKKS system is an example of such homomorphic encryption. In particular, the main parameters of the CKKS system are Q (modulus) and N (ring degree), as described above. The CKKS plaintext is represented as a polynomial of N−1 degree or less composed of integer coefficients, which may encode approximately N/2 complex values.

### 3. Batched Convolution Operation

In an embodiment of the present disclosure, an efficient batched convolution procedure using the CKKS is described. Here, it is assumed that N/2 images are given, and each image may be composed of Cᵢₙ h×w pixel matrices.

For each: 0≤i<h, 0≤j<w, 0≤k<Cᵢₙ, in an embodiment of the present disclosure, the ciphertext such as the following Equation 11 may be defined.

$$( {a}_{ij}^{( k )} , {b}_{ij}^{( k )} ) ∈ {R}_{Q} [ X ] / ( {X}^{N} + 1 ) \qquad [ Equation 11 ]$$

This ciphertext may be an encrypted N/2 value corresponding to pixel positions (i, j) in channel k of all images included in the batch.

It may be assumed that the convolution layer may be composed of a kernel matrix

$${K}_{ij} = ( {K}_{ij}^{( kl )} )$$

of dimension f×f for: 0≤i<Cin, 0≤j<Cout.

The polynomial representation may be defined as the following Equation 12.

$${a}_{ij}^{( k )} = {\sum }_{ℓ = 0}^{N - 1} {( {a}_{ij}^{( k )} )}_{ℓ} {X}^{ℓ} , {b}_{ij}^{( k )} = {\sum }_{ℓ = 0}^{N - 1} {( {b}_{ij}^{( k )} )}_{ℓ} {X}^{ℓ} \qquad [ Equation 12 ]$$

In addition, the following polynomial matrices may be defined as the following Equation 13.

### [Equation 13]

$${A}_{k , ℓ} ( Y ) = {\sum }_{i = 0}^{h - 1} {\sum }_{j = 0}^{ω - 1} {( {a}_{ij}^{( k )} )}_{ℓ} {Y}^{i ω + j} ,$$

$${B}_{k , ℓ} ( Y ) = {\sum }_{i = 0}^{h - 1} {\sum }_{j = 0}^{ω - 1} {( {b}_{ij}^{( k )} )}_{ℓ} {Y}^{i ω + j} \backslash$$

Here, A=(A_{k,l})(Y))_{0≤k<C}_{ᵢₙ}_{, 0≤l<N}∈(R_{Q}[Y]/Y^{hw}−1))^{C}^{ᵢₙ}^{×N} and B=(Bk,l)(Y))_{0≤k<C}_{ᵢₙ}_{, 0≤l<N}∈(R_{Q}[Y]/Y_{hw}−1))^{C}^{ᵢₙ}^{×N} may be encrypted input batches of the convolutional layer.

The main result according to an embodiment of the present disclosure is the following Equation 14.

$${A}^{′} = K \cdot A mod ( {Y}^{h ω} - 1 ) , \qquad [ Equation 14 ]$$

$${B}^{′} = K \cdot B mod ( {Y}^{h ω} - 1 )$$

Here, K is a matrix as the following Equation 15.

$${( {\sum }_{k = 0}^{f - 1} {\sum }_{l = 0}^{f - 1} {K}_{ij}^{( kl )} {Y}^{{ω}^{2} - k ω - l} )}_{0 \leq i < {C}_{out} , 0 \leq j < {C}_{in}} \qquad [ Equation 15 ]$$

In algorithmic form, this may provide the following procedure for evaluating the convolution for the input batch in the homomorphic encryption method.

### Input

A polynomial pair

$$( {a}_{ij}^{( k )} , {b}_{ij}^{( k )} ) ∈ {R}_{Q} [ X ] / ( {X}^{N} + 1 )$$

that encrypts a vector composed of N/2 values for the pixel positions (i,j) of each channel k. Here, the coefficients for the degree 1 of

$${( {a}_{ij}^{( k )} )}_{ℓ} or {( {b}_{ij}^{( k )} )}_{ℓ}$$

may be respectively called

$${( {a}_{ij}^{( k )} )}_{ℓ} , {( {b}_{ij}^{( k )} )}_{ℓ} .$$

(where, 0≤ [symbol] <N))

### Output

A polynomial pair

$$( {a}_{ij}^{′ ( k )} , {b}_{ij}^{′ ( k )} ) ∈ {R}_{Q} [ X ] / ( {X}^{N} + 1 )$$

that encrypts N/2 values of pixel positions (i,j) of channel k across the entire output batch

### Iterative Performance

Iterate over channel index k from 0 to Cᵢₙ:
Iterate over coefficient index 1 from 0 to N−1:

$$\cdot {A}_{k , ℓ} ( Y ) = {\sum }_{i = 0}^{h - 1} {\sum }_{j = 0}^{ω - 1} {( {a}_{ij}^{( k )} )}_{ℓ} {Y}^{i ω + j}$$

$$\cdot {B}_{k , ℓ} ( Y ) = {\sum }_{i = 0}^{h - 1} {\sum }_{j = 0}^{ω - 1} {( {b}_{ij}^{( k )} )}_{ℓ} {Y}^{i ω + j}$$

Iterate over output channel index 1 from 0 to Cₒᵤₜ:

$$\cdot ← {( {A}_{k , ℓ} )}_{0 \leq k < {C}_{in} , 0 \leq ℓ < N} ;$$

$$\cdot ← {( {B}_{k , ℓ} )}_{0 \leq k < {C}_{in} , 0 \leq ℓ \leq N} ;$$

$$\cdot ← {( {k , ℓ}_{} )}_{0 \leq k < {C}_{out} , 0 \leq ℓ < {C}_{in}} ;$$

$$\cdot ← \cdot mod {Y}^{h ω} - 1 ;$$

$$\cdot ← \cdot mod {Y}^{h ω} - 1 ;$$

Iterate over output channel index k from 0 to Cₒᵤₜ:
Iterate over i from 0 to h−1:
Iterate over j from 0 to w−1:

$${a}_{ij}^{′ ( k )} = {\sum }_{ℓ = 0}^{N - 1} {{A}_{k , ℓ}^{′} ( Y )}^{i ω + j} {X}^{ℓ}$$

$${b}_{ij}^{′ ( k )} = {\sum }_{ℓ = 0}^{N - 1} {{B}_{k , ℓ}^{′} ( Y )}^{i ω + j} {X}^{ℓ}$$

### Return

$$\vert ( {a}_{ij}^{′ ( k )} , {b}_{ij}^{′ ( k )} )$$

The main results of this disclosure are as follows.

The batched convolutional layer may be computed as a two-plaintext polynomial matrix multiplication between the public polynomial matrix K and the input polynomial matrices A, B for the ciphertext. The multiplication operations may be converted into a very efficient floating-point linear algebra library using various computer algebra techniques.

In particular, when w is a primitive L-th root of unity, it may be computed as shown in Equation 16 below.

$${A}^{′} ( {ω}^{ℓ} ) = K ( {ω}^{ℓ} ) \cdot A ( {ω}^{ℓ} ) , \qquad [ Equation 16 ]$$

$${B}^{′} ( {ω}^{ℓ} ) = K ( {ω}^{ℓ} ) \cdot B ( {ω}^{ℓ} )$$

Here, [symbol] may be calculated by performing coordinate-wise number theoretic transform (NTT) or discrete Fourier transform (DFT) on A, B, and [symbol] may be calculated in advance.

When the degree L of NTT is equal to hw, it may be compatible with polynomial multiplication on X^{hw}−1. A′, B′ are restored through coordinate-wise inverse NTT or inverse DFT, and if L≠hw, X^{hw}−1 modular remainder operation may be added if necessary.

As a result, the entire convolution operation may be reduced to O(hW) matrix operations on complex numbers or modular integers Q. Thereafter, a high-performance floating-point matrix multiplication library such as the dgemm command of Basic Linear Algebra Subroutines (BLAS) may be used through various numerical calculation techniques.

### 4. Side Remarks

The present disclosure enables removal of unnecessary pixels and downsampling among calculation results to be performed very efficiently. In general, some convolutional layers use stride S>1, and in this case, only 1/S of the output result pixels is kept and the rest is discarded. Since the encryption structure used in this disclosure encrypts the information of all images for one pixel position of one channel into one ciphertext, unnecessary pixels may be easily removed simply by removing the corresponding ciphertext during the cleaning or downsampling process.

In addition, up to N images may be packed through complex packing. In this case, images u and v may be paired and all pixel values of each channel may be converted to complex numbers in the form of

$${u}_{ij}^{( ℓ )} + i \cdot {v}_{ij}^{( ℓ )}$$

and stored. Alternatively, coefficient encoding may be used to directly encode N images into one ciphertext, and this disclosure may be applied to this method without modification.

Conversely, if less than N/2 images need to be packed, dummy images filled with 0 may be added, or an encryption method using the module-LWE format may be used (coefficient encoding method may be utilized).

This structure is also compatible with the last fully-connected layer, which may also be similarly reduced to two plaintext-plaintext matrix multiplication operations.

Although the CKKS method is described in this disclosure, this is only an embodiment and may be applied to all RLWE-based homomorphic encryption systems. In addition, although the square filter is described in this disclosure, this is also only an embodiment and may be applied to a rectangular filter.

The method of the present disclosure may also be extended to 3D-convolution in video processing.

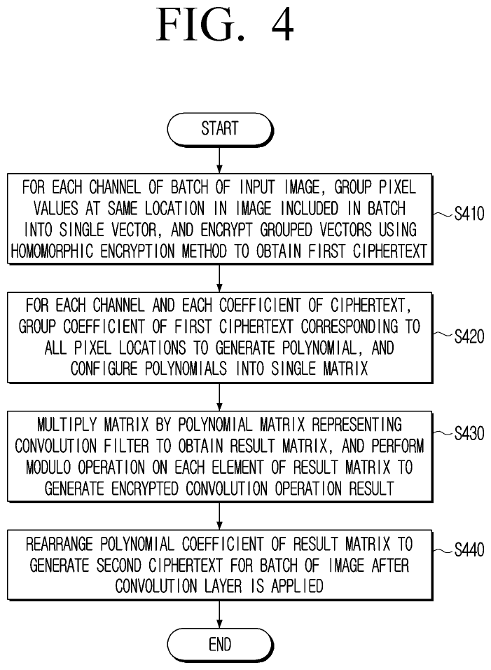

FIG. 4 is a flowchart for describing a method for performing a convolutional layer operation of a convolutional neural network according to an embodiment of the present disclosure.

The electronic device 100 groups pixel values at the same location in the images included in the batch into one vector for each channel of a batch of input images, and encrypts the grouped vectors using a homomorphic encryption method to obtain a first ciphertext (S410).

Specifically, the electronic device 100 may configure pixel values for N/2 images of each location (i,j) for each channel k for each pixel position for a batch of input images into a single vector, and this vector may be encrypted in the CKKS method to become the first ciphertext

$$( {a}_{ij}^{( k )} , {b}_{ij}^{( k )} ) .$$

For each channel and each coefficient of the ciphertext, the electronic device 100 groups the coefficients of the first ciphertext corresponding to all pixel positions to generate a polynomial, and configures the polynomials into a matrix (S420).

Specifically, for the coefficient 1 of the ciphertext

$${( {a}_{ii}^{( k )} )}_{ℓ} ,$$

the polynomial A_{k,l}(Y) may be generated by mapping. Y^{iw+j} to an exponent by location, and these polynomials may be configured into a matrix of size Cᵢₙ×N to obtain matrices A and B.

The electronic device 100 obtains a result matrix by multiplying the matrix by a polynomial matrix representing a convolution filter, and performs a modulo operation on each element of the result matrix to generate an encrypted convolution operation result (S430).

Here, the convolution filter matrix may be a matrix composed of a polynomial of Y. In particular, the result matrix A′, B′ may be obtained by multiplying the input matrices A and B with K, and then taking the remainder after dividing by Y^{hw}−1.

In addition, the input may be encrypted matrices A, B, and the filter matrix K may be a plaintext, i.e., an unencrypted public polynomial matrix. The operation may be performed in the form of a plaintext matrix×ciphertext matrix.

The electronic device 100 rearranges the polynomial coefficients of the result matrix to generate a second ciphertext for a batch of images after the convolution layer is applied (S440).

Specifically, the electronic device 100 may perform an inverse transformation on the coefficients of the result matrices A′, B′ to re-encrypt N/2 image values of each pixel position (i, j) to generate the second ciphertext.

Meanwhile, in an embodiment of the present disclosure, the second ciphertext may be encrypted using the same homomorphic encryption method (e.g., CKKS homomorphic encryption) as the first ciphertext.

According to an embodiment of the present disclosure, the electronic device 100 converts the polynomial matrix into a scalar matrix using number theoretic transform (NTT) or discrete Fourier transform (DFT) to evaluate a multiplication of the polynomial matrix, multiplies the scalar matrices, and then obtains a product of the polynomial matrix through the corresponding inverse transformation.

According to an embodiment of the present disclosure, the electronic device 100 may perform a preprocessing or postprocessing process including stride, downsampling, or invalid pixel removal by discarding one ciphertext from the entire batch.

Although various embodiments have been described above, each embodiment is not necessarily implemented individually, and may be implemented together in a single product by being combined in whole or in part with at least one other embodiment.

Various embodiments of the present disclosure may be implemented by software including instructions stored in a machine-readable storage medium (for example, a computer-readable storage medium). A machine may be a device that invokes the stored instruction from the storage medium and may be operated depending on the invoked instruction, and may include the electronic devices 100 and 200 according to the disclosed embodiments.

For example, a non-transitory readable storage medium storing software for sequentially performing various steps as illustrated in FIG. 4 may be provided.

A device equipped with such a non-transitory readable medium can perform operations such as public key generation, encryption, and decryption described in the various embodiments described above.

The term “non-transitory” in the non-transitory readable storage medium means that the storage medium is tangible without including a signal, and does not distinguish whether data are semi-permanently or temporarily stored in the storage medium.

Alternatively, a program for performing the method according to the various embodiments described above may be distributed online through an application store. In case of the online distribution, at least a portion of the computer program product may be at least temporarily stored in a storage medium such as a memory of a server of a manufacturer, a server of an application store, or a relay server or be temporarily generated.

Each of components (for example, modules or programs) according to various embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Although the present disclosure has been described with reference to the accompanying drawings, the scope of the present disclosure is determined by the claims to be described below and should not be construed as being limited to the foregoing embodiments and/or drawings. It should be clearly understood that improvements, modifications, and alterations of the present disclosure described in claims that are obvious to those skilled in the art are also included in the scope of the rights of the present disclosure.

[Description of reference numerals]

| | |
|---|---|
| 100: Electronic device | 110: Memory |
| 120: Processor | 130: Communication device |
| 140: Display | 150: Manipulation input device |

1. A method for performing convolutional neural network operations on a batch of input images using homomorphic encryption, comprising:
for each channel of the batch of the input images, grouping pixel values at the same location in the images included in the batch into a single vector, and encrypting the grouped vectors using a homomorphic encryption method to obtain a first ciphertext;
for each channel and each coefficient of the ciphertext, grouping coefficients of the first ciphertext corresponding to all pixel locations to generate polynomials, and configuring the polynomials into a single matrix;
multiplying the matrix by a polynomial matrix representing a convolution filter to obtain a result matrix, and performing a modulo operation on each element of the result matrix to generate an encrypted convolution operation result, the operation being performed on unencrypted matrices; and
rearranging polynomial coefficients of the result matrix to generate a second ciphertext for the batch of the images after the convolution layer is applied,
wherein the second ciphertext is encrypted by the same homomorphic encryption method as the first ciphertext.

2. The method of claim 1, wherein the first ciphertext and the second ciphertext are generated using an approximate homomorphic encryption scheme of a Cheon-Kim-Kim-Song (CKKS) method.

3. The method of claim 1, wherein the polynomial matrix is composed of a kernel having a rectangular or squared shape.

4. The method of claim 1, further comprising:
converting the polynomial matrix into a scalar matrix using a number theoretic transform (NTT) or a discrete Fourier transform (DFT) to evaluate a multiplication of the polynomial matrix, multiplying the scalar matrices, and then obtaining a product of the polynomial matrix through a corresponding inverse transformation.

5. The method of claim 1, further comprising:
performing a preprocessing or postprocessing process including stride, downsampling, or invalid pixel removal by discarding one ciphertext from the entire batch.

6. The method of claim 1, wherein the method is applied to a three-dimensional convolution operation on a plurality of image frames or video data.

7. An electronic device, comprising:
a memory configured to store instructions; and
a processor configured to execute the instructions;
wherein the processor is configured to, for each channel of the batch of the input images, group pixel values at the same location in the images included in the batch into a single vector, and encrypt the grouped vectors using a homomorphic encryption method to obtain a first ciphertext,
for each channel and each coefficient of the ciphertext, group coefficients of the first ciphertext corresponding to all pixel locations to generate polynomials, and configure the polynomials into a single matrix,
multiply the matrix by a polynomial matrix representing a convolution filter to obtain a result matrix, and perform a modulo operation on each element of the result matrix to generate an encrypted convolution operation result, the operation being performed on unencrypted matrices, and
rearrange polynomial coefficients of the result matrix to generate a second ciphertext for the batch of the images after the convolution layer is applied, and the second ciphertext is encrypted by the same homomorphic encryption method as the first ciphertext.

8. The electronic device of claim 7, wherein the first ciphertext and the second ciphertext are generated using an approximate homomorphic encryption scheme of a Cheon-Kim-Kim-Song (CKKS) method.

9. The electronic device of claim 7, wherein the polynomial matrix is composed of a kernel having a rectangular or squared shape.

10. The electronic device of claim 7, wherein the processor is configured to convert the polynomial matrix into a scalar matrix using number theoretic transform (NTT) or discrete Fourier transform (DFT) to evaluate a multiplication of the polynomial matrix, multiply the scalar matrices, and then obtain a product of the polynomial matrix through a corresponding inverse transformation.

11. The electronic device of claim 7, wherein the processor is configured to perform a preprocessing or postprocessing process including stride, downsampling, or invalid pixel removal by discarding one ciphertext from the entire batch.
